(19) United States
(12) Patent Application Publication
(10) Pub. No.: US 2025/0326329 A1
(43) Pub. Date: Oct. 23, 2025

(54) METHOD FOR CONTROLLING A FUEL CELL OF A WORK MACHINE

(71) Applicant: MANITOU BF, ANCENIS (FR)

(72) Inventors: Valentin BREHIER, ANCENIS (FR); Xavier SCHELL, ANCENIS (FR)

(21) Appl. No.: 18/855,095

(22) PCT Filed: Mar. 22, 2023
(86) PCT No.: PCT/EP2023/057358

§ 371 Date: Jun. 30, 2025

(30) Foreign Application Priority Data
Apr. 12, 2022 (FR) FR2203357

(51) Int. Cl. B60L 58/30; B60L 3/12; B60L 58/40; E02F 9/20

(52) U.S. Cl. CPC B60L 58/30; B60L 3/12; B60L 58/40; B60L 2200/42; B60L 2250/22; B60L 2260/22; E02F 9/2091

(57) ABSTRACT

A method of controlling a fuel cell of a working machine is disclosed, the method including the following steps: determining an operating mode of the working machine from at least two operating modes as a function of at least one variable chosen from: a driver presence variable, a motor speed variable, a machine speed variable, a loading mode active variable, a stabilizer variable, a charging variable, and a control activity variable; determining a state of charge of the energy storage unit; and controlling the fuel cell using a predetermined set point as a function of the state of charge of the energy storage unit and the operating mode of the working machine so determined.

### TECHNICAL FIELD

The invention relates to the field of working machines including a load-handling device, an electric motor configured to move the working machine or to actuate the load-handling device, an energy storage unit configured to supply the electric motor with electrical energy and a fuel cell generating electrical energy intended to power the electric motor. A machine of this kind may in particular take the form of a telescopic arm front loader, a mechanical shovel loader, a bucket loader, etc.

The invention relates more particularly to the field of methods for controlling a fuel cell of a working machine.

### Technological Background

There are known from the prior art and in particular from the document WO2008041892 site machines including a power source, which may be an internal combustion engine or a fuel cell, and a plurality of power consuming systems connected to the power source. The machine also includes an external power source, which may be a battery.

The above document further concerns a method for actuating the working machine which, after detection of a power demand operational parameter such as pressing on a brake pedal, has provision for balancing power supplied with power demanded in accordance with a real-time prediction model taking into account the detection of the operational parameter. If the power demanded is greater than the power supplied, balancing is effected by adding to the power source torque the torque from the external power source. The external power source therefore makes it possible in particular to supply the additional power predicted by the prediction model, at least temporarily, to allow sufficient time for the main source to reach the necessary power.

However, a method of the above kind is complex to implement and necessitates powerful computers to calculate in real time the predicted machine power. Furthermore, with a method of this kind and in the case of a fuel cell as power source, there is provision for constantly changing the set point of the cell as soon as the power demanded is modified, which can cause premature deterioration of the fuel cell.

### SUMMARY

One idea behind the invention is to simplify control of the fuel cell.

In one embodiment the invention provides a method of controlling a fuel cell of a working machine including a load-handling device formed of an arm and a tool, at least one electric motor that is configured to move the working machine and/or to actuate the load-handling device, an energy storage unit configured to supply energy to the at least one electric motor and a fuel cell that is connected to the energy storage unit and is configured to charge the energy storage unit, a first control member configured to control the electric motor and a second control member to control the load-handling device, the method including the following steps:
determining an operating mode of the working machine as one of at least two operating modes as a function of at least one variable chosen from:
a ‘driver presence’ variable representing the presence of a person on a driver's seat of the working machine;
a ‘machine speed’ variable representing the speed of movement of the working machine;
a ‘loading mode active’ variable representing the activity of the load-handling device;
a ‘stabilizer’ variable representing the position of one or more stabilizers;
a ‘charging’ variable’ representing the state of a button actuating charging mode; and
a ‘control activity’ variable representing the activity of the first control member and/or of the second control member;
determining a state of charge of the energy storage unit; and
controlling the fuel cell using a predetermined set point as a function of the state of charge of the energy storage unit and the operating mode of the working machine so determined.

Thanks to the above features, the control method enables simple control of the fuel cell by means of identification of modes of operation and the state of charge of the energy storage unit. In fact, the determination of the operating mode enables simple evaluation of the power that will be demanded of the energy storage unit by means of various variables so as to adapt the set point of the fuel cell to charge the storage unit as required. Furthermore, the method enables adaptation of the fuel cell set point as a function of the state of charge of the energy storage unit, for example by providing a fuel cell set point power that is higher or lower according to whether the energy storage unit is holding a low charge or an average charge or is fully charged.

Embodiments of a method of this kind may have one or more of the following features.

In one embodiment the working machine includes a first electric motor that is configured to move the working machine and a second electric motor that is configured to actuate the load-handling device.

In one embodiment the operating mode of the working machine may equally be determined as a function of a ‘motor speed’ variable representing the speed of the second electric motor that is configured to actuate the load-handling device.

In one embodiment one of the operating modes is an idling mode that is determined by means of the ‘driver presence’ variable, the ‘control activity’ variable and optionally the aforementioned ‘motor speed’ variable.

In one embodiment the method comprises the following steps:
receiving the ‘driver presence’ variable and the ‘control activity’ variable, the ‘driver presence’ variable being adapted to assume a first value when a person is present on a driver's seat of the working machine and a second value when nobody is present on the driver's seat, the ‘control activity’ variable being adapted to assume a first value when the first control member and the second control member are in a neutral position and adapted to assume a second value when the first control member or the second control member is in an active position;
determining that the operating mode is the idling mode when the ‘control activity’ variable is equal to the first value and the ‘driver presence’ variable is equal to the second value.

In one embodiment the method comprises the following steps:
receiving the ‘driver presence’ variable, the ‘control activity’ variable and the ‘motor speed’ variable, the ‘driver presence’ variable being adapted to assume a first value when a person is present on a driver's seat of the machine and a second value when nobody is present on the driver's seat, the ‘control activity’ variable being adapted to assume a first value when the first control unit and the second control unit are in a neutral position and adapted to assume a second value when the first control unit or the second control unit is in an active position;
comparing the ‘motor speed’ variable to a predetermined motor speed threshold,
determining that the operating mode is the idling mode when the ‘motor speed’ variable assumes a value below the predetermined motor speed threshold, the ‘control activity’ variable is equal to the first value and the ‘driver presence’ variable is equal to the second value.

In one embodiment one of the operating modes is an idling mode determined by means of the ‘charging’ variable, the ‘control activity’ variable and optionally the ‘motor speed’ variable.

In one embodiment the method comprises the following steps:
receiving the ‘charging’ variable and the ‘control activity’ variable, the ‘charging’ variable being adapted to assume a first value when the button actuating charging mode is in the active state and a second value when the button actuating charging mode is in the inactive state, the ‘control activity’ variable being adapted to assume a first value when the first control member and the second control member are in a neutral position and adapted to assume a second value when the first control member or the second control member is in an active position;
determining that the operating mode is the idling mode when the ‘control activity’ variable is equal to the first value and the ‘charging’ variable is equal to the second value.

In one embodiment the method comprises the following steps:
receiving the ‘charging’ variable, the ‘control activity’ variable and the ‘motor speed’ variable, the ‘charging’ variable being adapted to assume a first value when the button actuating charging mode is in the active state and a second value when the button actuating charging mode is in the inactive state, the ‘control activity’ variable being adapted to assume a first value when the first control member and the second control member are in a neutral position and adapted to assume a second value when the first control member or the second control member is in an active position;
comparing the ‘motor speed’ variable to a predetermined motor speed threshold;
determining that the operating mode is the idling mode when the ‘motor speed’ variable assumes a value below the predetermined motor speed threshold, the ‘control activity’ variable is equal to the first value and the ‘charging’ variable is equal to the second value.

In one embodiment the first control member is a three-position forward/neutral/reverse selector adapted to assume three positions, the neutral position, a forward position and a reverse position, the selector being in an active position in the forward position that is configured to deliver a demand for forward movement of the working machine and in the reverse position that is configured to deliver a demand for reverse movement of the working machine.

In one embodiment the second control member is a joystick adapted to be tilted upward, downward, toward the right or toward the left. Tilting the joystick upward delivers a demand for lowering the arm, tilting the joystick downward delivers a demand for raising the arm, tilting to the left or to the right delivers a demand for tilting the tool in one direction or the other.

In one embodiment when the first control member is a three-position selector and the second control member is a joystick the ‘control activity’ variable is adapted to assume the first value when the three-position selector is in the neutral position and the joystick is in the neutral position, not tilted by a user and adapted to assume a second value when the three-position selector is in the forward position or the reverse position or the joystick has been tilted by a user relative to the neutral position.

In one embodiment the ‘driver presence’ variable is obtained with the aid of a presence sensor configured to deliver a signal when a measurement of the weight on the seat above a particular weight threshold is detected, the method including a step of comparison of a measurement of the weight on the seat to a particular weight threshold value, the particular weight threshold value being for example greater than 10 kg, more preferably greater than 15 kg, and a step of assigning the first value to the ‘driver presence’ variable when the measured weight is above said predetermined threshold.

In one embodiment the electric motor includes a motor shaft and the ‘motor speed’ variable is measured with the aid of a speed sensor delivering a measurement representing the rotation speed of the motor shaft of the electric motor, for example a Hall-effect capacitive sensor.

In one embodiment the predetermined motor speed threshold is equal to the value of the speed of the electric motor when idling plus a constant, said predetermined motor speed threshold being for example between 50 rpm and 1000 rpm inclusive, preferably between 100 rpm and 500 rpm inclusive, for example equal to 300 rpm.

In one embodiment one of the operating modes is a charging mode that is determined by means of the ‘driver presence’ variable, the ‘charging’ variable, the ‘control activity’ variable and optionally the ‘motor speed’ variable.

In one embodiment the method comprises the following steps:
receiving the ‘driver presence’ variable, the ‘control activity’ variable and the ‘charging’ variable, the ‘driver presence’ variable being adapted to assume a first value when a person is present on a seat of the machine and a second value when nobody is present on the seat, the ‘charging’ variable being adapted to assume a first value when the button actuating charging mode is in the active state and a second value when the button actuating charging mode in the inactive state, the ‘control activity’ variable being adapted to assume a first value when the first control member and the second control member are in a neutral position and adapted to assume a second value when the first control member or the second control member is in an active position;
determining that the operating mode is the charging mode when the ‘control activity’ variable is equal to the first value, the ‘driver presence’ variable is equal to the first value and the ‘charging’ variable is equal to the first value.

In one embodiment the method comprises the following steps:
receiving the ‘driver presence’ variable, the ‘control activity’ variable, the ‘motor speed’ variable and the ‘charging’ variable’, the ‘driver presence’ variable being adapted to assume a first value when a person is present on a seat of the machine and a second value when nobody is present on the seat, the ‘charging’ variable’ being adapted to assume a first value when the button actuating the charging mode is in the active state and the second value when the button actuating the charging mode is in the inactive state, the ‘control activity’ variable being adapted to assume a first value when the first control member and the second control member are in a neutral position and adapted to assume a second value when the first control member or the second control member is in an active position;
comparing the ‘motor speed’ variable to a predetermined motor speed threshold;
determining that the operating mode is the charging mode when the ‘motor speed’ variable assumes a value below the predetermined motor speed threshold, the ‘control activity’ variable is equal to the first value, the ‘driver presence’ variable is equal to the first value and the ‘charging’ variable’ is equal to the first value.

In one embodiment one of the operating modes is a road mode which is determined by means of the «machine speed» variable, optionally by the «‘motor speed’ variable, and optionally by the ‘control activity’ variable.

In one embodiment the method comprises the following steps:
receiving the ‘machine speed’ variable;
comparing the ‘machine speed’ variable to a predetermined machine speed threshold;
determining that the operating mode is the road mode when the ‘machine speed’ variable assumes a value above the predetermined machine speed threshold.

In one embodiment the method comprises the following steps:
receiving the ‘machine speed’ variable and the ‘control activity’ variable, the ‘control activity’ variable being adapted to assume a first value when the first control member and the second control member are in a neutral position and adapted to assume a second value when the first control member or the second control member is in an active position;
comparing the ‘machine speed’ variable to a predetermined machine speed threshold;
determining that the operating mode is the road mode when the ‘control activity’ variable is equal to the second value and the ‘machine speed’ variable has a value above the predetermined machine speed threshold.

In one embodiment the method comprises the following steps:
receiving the ‘machine speed’ variable, the ‘control activity’ variable and the ‘motor speed’ variable, the ‘control activity’ variable being adapted to assume a first value when the first control member and the second control member are in a neutral position and adapted to assume a second value when the first control member or the second control member is in an active position;
comparing the ‘motor speed’ variable to a predetermined motor speed threshold;
comparing the ‘machine speed’ variable to a predetermined machine speed threshold;
determining that the operating mode is the road mode when the ‘motor speed’ variable assumes a value above the predetermined motor speed threshold and the ‘machine speed’ variable assumes a value above the predetermined machine speed threshold or when the ‘control activity’ variable is equal to the second value and the ‘machine speed’ variable has a value above the predetermined machine speed threshold.

In one embodiment the ‘machine speed’ variable is measured with the aid of a speed sensor, for example a Hall-effect capacitive sensor situated in a gearbox or on a rear axle.

In one embodiment the predetermined machine speed threshold is for example between 10 and 30 kph inclusive, preferably between 10 and 20 kph inclusive, for example equal to 16 kph.

In one embodiment one of the operating modes is a charging mode that is determined by means of the ‘machine speed’ variable, the ‘control activity’ variable, the ‘loading mode active’ variable and optionally the ‘motor speed’ variable.

In one embodiment the method comprises the following steps:
receiving the ‘machine speed’ variable, the ‘control activity’ variable and the ‘loading mode active’ variable, the ‘loading mode active’ variable being adapted to assume a first value in response to the detection of a hydraulic flowrate set point of a cylinder for tilting the tool included in a predetermined range for a duration above a predetermined duration threshold and to the detection of an angle of the arm in a predetermined range, and to assume a second value in the contrary case, the ‘control activity’ variable being adapted to assume a first value when the first control member and the second control member are in a neutral position and adapted to assume a second value when the first control member or the second control member is in an active position;
comparing the ‘machine speed’ variable to a predetermined machine speed threshold;
determining that the operating mode is the charging mode when the ‘control activity’ variable is equal to the second value, the ‘machine speed’ variable assumes a value below the predetermined machine speed threshold and the ‘loading mode active’ variable is equal to the first value.

In one embodiment the method comprises the following steps:
receiving the ‘machine speed’ variable, the ‘motor speed’ variable, ‘control activity’ variable and the ‘loading mode active’ variable, the ‘loading mode active’ variable being adapted to assume a first value in response to detection of a hydraulic flowrate set point of a cylinder for tilting the tool in a predetermined range for a duration above a predetermined duration threshold and to the detection of an angle of the arm in a predetermined range and to assume a second value in the contrary case, the ‘control activity’ variable being adapted to assume a first value when the first control member and the second control member are in a neutral position and adapted to assume a second value when the first control member or the second control member is in an active position;
comparing the ‘motor speed’ variable to a predetermined motor speed threshold;
comparing the ‘machine speed’ variable to a predetermined machine speed threshold;
determining that the operating mode is the charging mode when the ‘motor speed’ variable assumes a value above the predetermined ‘motor speed’ threshold, the ‘machine speed’ variable assumes a value below the predetermined machine speed threshold and the ‘loading mode active’ variable is equal to the first value or when the value of the ‘control activity’ variable is equal to the second value, the ‘machine speed’ variable assumes a value below the predetermine machine speed threshold and the ‘loading mode active’ variable is equal to the first value.

In one embodiment a hydraulic flowrate set point of a cylinder for tilting the tool is detected by means of a flowrate sensor mounted on a tilt cylinder. The hydraulic flowrate set point of the tilt cylinder is for example between −100% and −30% inclusive of the predetermined maximum flowrate of the tilt cylinder and between 30% and 100% inclusive of the predetermined maximum flow rate of the tilt cylinder. Negative values of flowrate correspond to tilting of the tool in a loading direction and positive values correspond to tilting of the tool in a tipping direction. The predetermined duration threshold is for example greater than 1 second (sec), preferably between 1 and 2 sec inclusive, more preferably equal to 1.5 sec.

In one embodiment an angle of the arm is detected by means of an angle sensor situated in the vicinity of the arm. The predetermined range is for example between 0 and 10° inclusive and between 3° and 70° inclusive.

In one embodiment one of the operating modes is a handling mode determined by means of the ‘machine speed’ variable, the ‘loading mode active’ variable, the ‘stabilizer’ variable, the ‘control activity’ variable and optionally the ‘motor speed’ variable.

In one embodiment the method comprises the following steps:
receiving the ‘machine speed’ variable, the ‘control activity’ variable, the ‘loading mode active’ variable and the ‘stabilizer’ variable, the ‘loading mode active’ variable being adapted to assume a first value in response to the detection of a hydraulic flowrate set point of a cylinder for tilting the tool in a predetermined range for a duration above a predetermined duration threshold and the detection of an angle of the arm in a predetermined range and to assume a second value in the contrary case, the ‘stabilizer’ variable being adapted to assume a first value when at least one stabilizer is in an operating position and adapted to assume a second value when no stabilizer is in the operating position, the ‘control activity’ variable being adapted to assume a first value when the first control member and the second control member are in a neutral position and adapted to assume a second value when the first control member or the second control member is in an active position;
comparing the ‘machine speed’ variable to a predetermine machine speed threshold;
determining that the operating mode is the handling mode when the ‘control activity’ variable is equal to the second value, the ‘machine speed’ value has a value below the predetermined machine speed threshold, the ‘load-handling device active’ variable is equal to the first value and the ‘stabilizer’ variable is equal to the second value.

In one embodiment the method comprises the following steps:
receiving the ‘machine speed’ variable, the ‘motor speed’ variable, the ‘control activity’ variable, the ‘loading mode active’ variable and the ‘stabilizer’ variable, the ‘loading mode active’ variable being adapted to assume a first value in response to the detection of a hydraulic flowrate set point of a cylinder for tilting the tool in a predetermined range for a duration above a predetermined duration threshold and to the detection of an angle of the arm in a predetermined range and to assume a second value in the contrary case, the ‘stabilizer’ variable being adapted to assume a first value when at least one stabilizer in an operating position and adapted to assume a second value when no stabilizer is in the operating position, the ‘control activity’ variable being adapted to assume a first value when the first control member and the second control member are in a neutral position and adapted to assume a second value when the first control member or the second control member is in active position;
comparing the ‘motor speed’ variable to a predetermined motor speed threshold;
comparing the ‘machine speed’ variable to a predetermined machine speed threshold;
determining that the operating mode is the handling mode when the ‘motor speed’ variable assumes a value above the predetermined motor speed threshold, the ‘machine speed’ variable assumes a value below the predetermined machine speed threshold, the ‘load-handling device active’ variable is equal to the first value and the ‘stabilizer’ variable is equal to the second value or when the ‘control activity’ variable is equal to the second value, the ‘machine speed’ variable has a value below the predetermined machine speed threshold, the ‘load-handling device active’ variable is equal to the first value and the ‘stabilizer’ variable is equal to the second value.

In one embodiment one of the operating modes is a handling on stabilizers mode that is determined by means of the ‘machine speed’ variable, the ‘loading mode active’ variable, the ‘stabilizer’ variable, the ‘control activity’ variable and optionally the ‘motor speed’ variable.

In one embodiment the method comprises the following steps:
receiving the ‘machine speed’ variable, the ‘control activity’ variable, the ‘loading-mode activity’ variable and the ‘stabilizer’ variable, the ‘loading mode active’ variable being adapted to assume a first value in response to the detection of a hydraulic flowrate set point of a cylinder for tilting the tool in a predetermined range for a duration above a predetermined duration threshold and to the detection of an angle of the arm in a predetermined range, the ‘stabilizer’ variable being adapted to assume a first value when at least one stabilizer is in an operating position and adapted to assume a second value when there is no stabilizer in the operating position, the ‘control activity’ variable being adapted to assume a first value when the first control member and the second control member are in a neutral position and adapted to assume a second value when the first control member or the second control member is in an active position;
comparing the ‘machine speed’ variable to a predetermined machine speed threshold;
determining that the operating mode is the handling on stabilizers mode when the ‘control activity’ variable is equal to the second value, the ‘machine speed’ variable assumes a value below the predetermined machine speed threshold, the ‘load-handling device active’ variable is equal to the first value and the ‘stabilizer’ variable is equal to the first value.

In one embodiment the method comprises the following steps:
receiving the ‘machine speed’ variable, the ‘motor speed’ variable, the ‘control activity’ variable, the ‘loading mode active’ variable and the ‘stabilizer’ variable, the ‘loading mode active’ variable being adapted to assume a first value in response to the detection of a hydraulic flowrate set point of a cylinder for tilting the tool in a predetermined range for a duration above a predetermined duration threshold and to the detection of the angle of the arm in a predetermined range, the ‘stabilizer’ variable being adapted to assume a first value when at least one stabilizer is in an operating position and adapted to assume a second value when no stabilizer is in the operating position, the ‘control activity’ variable being adapted to assume a first value when the first control member and the second control member are in a neutral position and adapted to assume a second value when the first control member or the second control member is in an active position;
comparing the ‘motor speed’ variable to a predetermined motor speed threshold;
comparing the ‘machine speed’ variable to a predetermined machine speed threshold;
determining that the operating mode is the handling on stabilizers mode when the ‘motor speed’ variable has a value above the predetermined motor speed threshold, the ‘machine speed’ variable has a value below the predetermined machine speed threshold, the ‘load-handling device active’ variable is equal to the first value and the ‘stabilizer’ variable is equal to the first value or when the ‘control activity’ variable is equal to the second value, the ‘machine speed’ variable assumes a value below the predetermined machine speed threshold, the ‘load-handling device active’ variable is equal to the first value and the ‘stabilizer’ variable is equal to the first value.

In one embodiment the step of controlling the fuel cell includes the following sub-steps:
comparing the state of charge determined to a state of charge threshold;
when the state of charge is above the state of charge threshold controlling the fuel cell using a predetermined set point having a first set point value;
when the state of charge is below the state of charge threshold controlling the fuel cell using a predetermined set point having a second set point value, the second set point value being higher than the first set point value.

In one embodiment the step of determining the stated charge includes the following sub-steps:
determining the state of charge at a time t;
determining the state of charge at a time t+dt, dt being a predetermined time interval;
comparing the state of charge at time t and the state of charge at time t+dt;
when the state of charge at time t+dt is lower than the state of charge at time t, determining that the energy storage unit is in the discharging phase;
when the state of charge at time t+dt is greater than the state of charge at time t determining that the energy storage unit is in the charging phase;
wherein the step of controlling the fuel cell includes the following sub-steps in the discharging phase of the energy storage unit:
comparing the state of charge determined to a first state of charge threshold;
when the state of charge is above the first state of charge threshold controlling the fuel cell using a predetermined set point having a first set point value;
when the state of charge is below the first state of charge threshold controlling the fuel cell using a predetermined set point having a second set point value, the second set point value being higher than the first set point value;
and wherein the step of controlling the fuel cell includes the following sub-steps in the phase of charging the energy storage unit:
comparing the state of charge determined to a second state of charge threshold, the first state of charge threshold being different from the second state of charge threshold;
when the state of charge is above the second state of charge threshold controlling the fuel cell with a predetermined set point having the first set point value;
when the state of charge is below the second state of charge threshold controlling the fuel cell with a predetermined set point having the second set point value.

In one embodiment the second state of charge threshold is higher than the first state of charge threshold.

In one embodiment the first and second set point values correspond to two of the following set point values:
a ‘nil’ set point value for which the fuel cell is shut down;
an ‘idling’ set point corresponding to a power delivered by the fuel cell between 2 and 25% inclusive of a maximum power of the fuel cell;
an ‘average’ set point value corresponding to a power delivered by the fuel cell between 25 and 85% inclusive of the maximum power of the fuel cell;
a ‘maximum’ set point value corresponding to a power delivered by the fuel cell greater than 85% of the maximum power of the fuel cell.

In one embodiment the ‘average’ set point value is adjusted during the service life of the working machine by the following steps:
initializing the ‘average’ set point value to a predetermined initial set point value;
calculating an average power delivered during one or more cycles of activity of the working machine;
modifying the ‘average’ set point value as a function of the calculated average power. In one embodiment the fuel cell is a hydrogen fuel cell.

In one embodiment the energy storage unit includes one or more batteries, for example of the lead-acid type or of the lithium-ion type.

In one embodiment the invention also provides a control unit intended for a working machine including a load-handling device formed of an arm and a tool, at least one electric motor that is configured to move the working machine and/or to actuate the load-handling device, an energy storage unit configured to supply the electric motor with energy, a fuel cell that is connected to the energy storage unit and is configured to charge the energy storage unit, a first control member configured to control the electric motor and a second control member configured to control the load-handling device, the control unit being configured:
to determine an operating mode of the working machine from at least two operating modes as a function of at least one variable chosen from:
a ‘driver presence’ variable representing the presence of a person on a driver's seat of the working machine;
a ‘loading mode active’ variable representing the activity of the load-handling device;
a ‘loading mode active’ variable representing the activity of the load-handling device;
a ‘stabilizer’ variable representing the position of one or more stabilizers;
a ‘charging’ variable’ representing the state of a button actuating charging mode; and
a ‘control activity’ variable representing the activity of the first control member and of the second control member;
determining a state of charge of the energy storage unit; and
controlling the fuel cell using a predetermined set point as a function of the state of charge of the energy storage unit and of the operating mode of the working machine so determined.

In one embodiment the invention also concerns a computer program product comprising program code instructions for the execution of the steps of a control method conforming to any of the embodiments described hereinabove when said program is executed by a control unit.

In one embodiment the invention also provides a working machine including a load-handling device formed of an arm and a tool, at least one electric motor that is configured to move the working machine and/or to actuate the load-handling device, an energy storage unit configured to supply the electric motor with energy and a fuel cell that is connected to the energy storage unit and is configured to charge the energy storage unit, and in which the working machine comprises a control unit conforming to any of the embodiments.

### BRIEF DESCRIPTION OF THE FIGURES

The invention will be better understood and other aims, details, features and advantages thereof will become clearly apparent in the course of the following description of particular embodiments of the invention given by way of non-limiting illustration only with reference to the appended drawings.

FIG. 1 is a schematic representation of one embodiment of a working machine in the form of a telescopic arm front loader.

FIG. 2 is a schematic depiction of the electrical power supply system of a working machine of the type represented in FIG. 1.

FIG. 3 represents a logic diagram of the step of determination of an operating mode in one embodiment of the method of controlling the fuel cell.

FIG. 4 is a diagram representing the set point value of the fuel cell as a function on the one hand and on the abscissa axis of the operating mode and on the other hand and on the ordinate axis the state of charge of the storage unit for a charging phase of the storage unit in one embodiment.

FIG. 5 is a diagram representing the set point value of the fuel cell as a function on the one hand and on the abscissa axis of the operating mode and on the other hand and on the ordinate axis of the state of discharge of the storage unit for a discharging phase of the storage unit in one embodiment.

### DESCRIPTION OF EMBODIMENTS

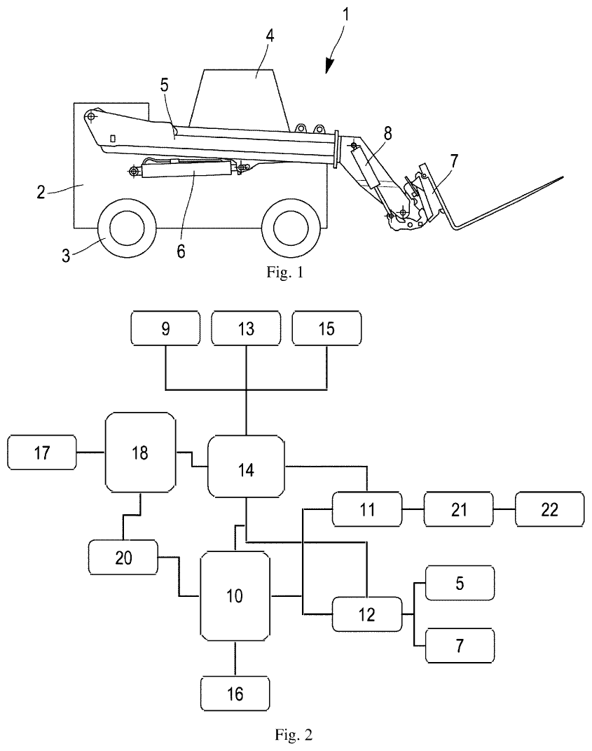

A working machine 1 is described with reference to FIG. 1. The working machine 1 includes a mobile chassis 2. To this end the working machine 1 includes wheels 3 or tracks and an electrical power supply system that is not represented. The electrical power supply system comprises an electric motor 11 for moving the working machine 1 and a transmission device that couples said electric motor 11 to the wheels 3 or the tracks, which enables movement of the working machine 1. The working machine 1 includes two axles each of which is mounted on the chassis 2 and each of which is fitted with two wheels 3.

The working machine 1 also includes a driver's cab 4 that is carried by the chassis 2. The driver's cab 4 is equipped with a driving station comprising a seat on which the driver can sit to drive the front loader. The driver's station also includes equipment for controlling the working machine 1, such as a steering wheel, an accelerator pedal, a brake pedal. The driver's station is also equipped with one or more actuator members for driving the movement of a load-handling device including for example a lifting arm 5.

The working machine 1 also includes one or more retractable stabilizers 9 that are fixed to the chassis 2. The stabilizers 9 can therefore go from a retracted position to an operating position in which the stabilizers 9 are in contact with the ground and at a distance from the wheels 3 and make it possible to increase the stability of the working machine 1. The working machine 1 may for example include two stabilizers 9 at the front on either side of the machine 1 or four stabilizers 9, one at the level of each of the wheels 3.

In one embodiment the lifting arm 5 is telescopic, that is to say its length is variable. To this end the lifting arm 5 includes at least two parts one of which slides inside the other and a telescoping cylinder, which is not depicted, which includes first and second ends respectively fixed to the first part and to the second part of the lifting arm 5. In this case the working machine 1 can in particular be a telescopic arm front loader. In another embodiment the lifting arm 5 is an arm of fixed length.

The working machine 1 also includes a lifting cylinder 6 that has a first end that is mounted on and articulated to the chassis 2 of the working machine 1 and a second end that is mounted on and articulated to the lifting arm 5.

Furthermore, the lifting arm 5 is also equipped with a tool 7, such as a bucket or a fork, which is intended to receive a load. The tool 7 is mounted on and articulated to the distal end of the lifting arm 5. The tool 7 is able to pivot relative to the lifting arm 5 with the aid of a tilt cylinder 8.

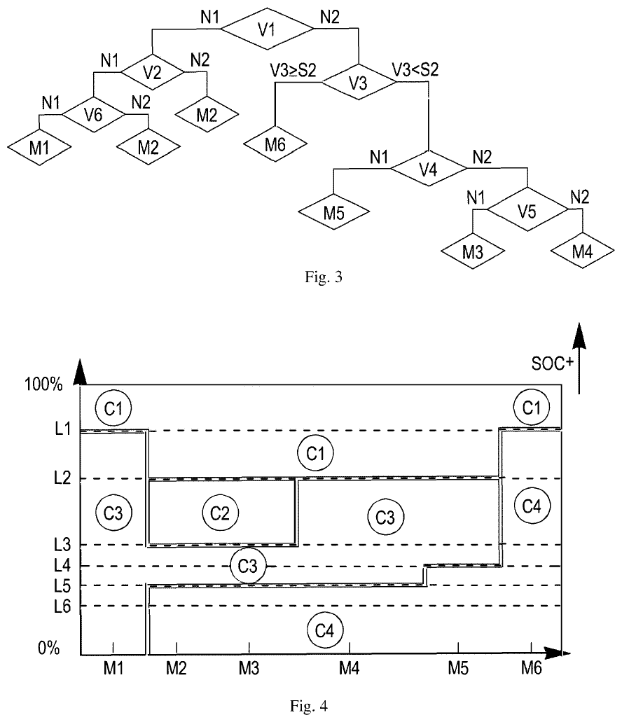

The various elements of the electrical power supply system of the working machine 1 are described below with reference to FIG. 2.

The working machine 1 includes an electrical energy storage unit 10. The electrical energy storage unit 10 includes for example one or more batteries, for example of the lead-acid type or the lithium-iron type. The electrical energy storage unit 10 is electrically connected to at least one electric motor 11 in order to supply it with energy.

In the embodiment represented the electric energy storage unit 10 powers the electric motor 11 to move the working machine 1 and a driving device 12 of the handling device including the lifting arm 5 and the tool 7, the driving device 12 also including an electric motor. The electrical motor 11 is intended to propel the working machine 1. To this end the electric motor 11 is coupled by a transmission device 21 to an axle 22 of the working machine 1 or to both axles 22. The transmission device 21 may be a mechanical device or a hydraulic device.

The device 12 driving the load-handling device may include an electric motor and electric actuators. The driving device 12 may equally well be an electrohydraulic device and include a pump driven by an electric motor, one or more hydraulic actuators, such as the cylinder 6 for raising the lifting arm 5, hydraulic distributors, etc.

The working machine 1 includes at least one control member 13 such as an accelerator pedal that is configured to deliver demands for actuation of the electric motor 11 to a control unit 14. The working machine 1 further includes at least one control member 9 such as a three-position forward/neutral/reverse selector that is configured to deliver demands for forward movement, reverse movement or a neutral position to the electric motor 11. When the control member 9 is not actuated it is in a neutral central position and when it is tilted by a user the control member 9 passes to a forward position to deliver a demand for forward movement and to a reverse position to deliver a demand for reverse movement. The working machine 1 also includes at least one control member 15 of the load-handling device, for example of the joystick type, which is configured to deliver to the control unit 14 demands for actuation of the load-handling device.

Furthermore, the working machine 1 includes a device 16 for evaluation of the state of charge that is associated with the electrical energy storage unit 10 and is configured to determine a value of the state of charge of the electrical energy storage unit 10 and to transmit it to the control unit 14. The state of charge is a relative measurement of the quantity of energy stored corresponding to the ratio between the charge in the electrical energy storage unit 10 at a certain moment and its original total capacity.

In one embodiment the device 16 for evaluation of the state of charge includes a voltage sensor that delivers a measurement of the open circuit voltage at the terminals of the electrical energy storage unit 10. The voltage at the terminals of the electrical energy storage unit 10 varying as a function of its level of charge, this kind of measurement of the voltage at the terminals of the electrical energy storage unit 10 enables estimation of its state of charge.

In another embodiment the state of charge evaluation device 16 includes a coulombmeter that measures and integrates the current during charging or discharging of the energy storage unit, which makes it possible to determine the quantity of charge injected into or withdrawn from the electrical energy storage unit 10 and thus to quantify its state of charge.

In a manner that is known in itself the control unit 14 is configured to control in particular the electric motor 11 and the device 12 driving the load handling device as a function of demands for actuation of the electric motor 11 and the load-handling device respectively delivered by the control members 9 and 13 and the control member 15.

The electrical power supply system includes a tank 17 intended to store hydrogen and a fuel cell 18.

The tank 17 is for example adapted to store hydrogen in the gas state at a maximum pressure between 300 and 700 bar inclusive, for example of the order of 350 bar. In another embodiment the tank 17 is adapted to store hydrogen in the solid state in the form of metal hydrides. In another embodiment the tank may equally be adapted to store hydrogen in the liquid state.

The tank 17 is connected to the fuel cell 18 by a circuit 19 that is in particular equipped with a pressure regulator that is not depicted for lowering the pressure of the hydrogen. The fuel cell 18 is furthermore equipped with an air compressor for compressing the combustion-supporting air at the input of the cells of the fuel cell 18. The fuel cell may equally include a humidifier device for humidifying the hydrogen and the air at the input of the fuel cell 18.

In a manner that is known in itself the fuel cell 18 is the location of an oxy-reduction reaction that transforms hydrogen from the tank 17 and oxygen from the air fed in by the compressor into electricity, water and heat.

The working machine 1 also includes a cooling device that is not represented for cooling the fuel cell 17 and a water collecting device that is not represented for collecting water ejected by the fuel cell 18.

The working machine 1 further includes power electronics 20 that include in particular a DC/DC voltage converter that is connected on one side to the fuel cell 18 and on the other side to the electrical energy storage device, here the batteries 10. The DC/DC voltage converter makes it possible to convert the voltage delivered by the fuel cell 18 to a voltage required by the batteries 18.

The control unit 14 is also configured to control the batteries 10 as a function of the power demanded by the electric motor 11 and the driving device 12 and to control the fuel cell 18 using a control method described in more detail below with reference to FIGS. 3 to 5.

In the working machine 1 as described the fuel cell 18 makes it possible to increase the autonomy of the storage unit 10 by supplying it with electrical energy in accordance with the set point applied to the fuel cell 18.

The inventors noticed that it was preferable to prevent the state of charge of the storage unit 10 reaching its 100% maximum value in order not to damage the storage unit 10 and the state of charge of the storage unit 10 reaching its minimum value so that the working machine 1 does not stop when there is potentially fuel remaining in the tank 17.

The inventors further noticed that it was possible to identify clearly distinct operating modes of a working machine 1 by means of different variables. In those operating modes the working machine 1 demands of the electric motor 11 and of the driving device 12 powers that are different and therefore loads the storage unit 10 to a greater or lesser degree.

This is why the inventors have proposed a method of controlling a fuel cell as described below.

Thus the method of controlling the fuel cell 18 includes the following steps:
determining an operating mode from a list of operating modes as a function of various variables;
determining a state of charge of the storage unit 10;
controlling the fuel cell using a predetermined set point as a function of the state of charge of the energy storage unit and the operating mode of the working machine so determined.

FIG. 3 represents a logic diagram of the step of determination of an operating mode of the method of controlling the fuel cell in accordance with one embodiment.

In the embodiment represented a list of operating modes has been drawn up:
a charging mode M1,
an idling mode M2,
a handling on stabilizers mode M3,
a handling mode M4,
a charging mode M5,
a road mode M6.

In order to determine the current operating mode of the working machine 1 the following list of variables has been used, as represented in FIG. 3:
a ‘motor speed’ variable representing the speed of the electric motor of the driving device 12, the ‘motor speed’ variable V1 having a value that is compared to a motor speed threshold S1;
a ‘control activity’ variable V1 representing the activity of the control member 9 and/or the control member 15, the ‘control activity’ variable V1 being adapted to assume a first value N1 when the control member 9 and the control member 15 are in a neutral position and adapted to assume a second value N2 when the control member 9 or the control member 15 is in an active position;
a ‘driver presence’ variable V2 representing the presence of a person on a driver's seat of the working machine 1, the ‘driver presence’ variable V2 being adapted to assume a first value N1 when a person is present on a seat of the machine and a second value N2 when nobody is present on the seat;
a ‘machine speed’ variable V3 representing the speed of movement of the working machine 1, the ‘machine speed’ variable V3 being a value that is compared to a machine speed threshold S2;
a ‘loading mode active’ variable V4 representing the activity of the load handling device, the ‘loading mode active’ variable being adapted to assume a first value N1 in response to the detection of a hydraulic flowrate set point of a tilt cylinder of the tool 7 in a predetermined range for a duration above a predetermined duration threshold and/or the detection of an angle of the arm in a predetermined range and assuming a second value N2 in the contrary case;
a ‘stabilizer’ variable V5 representing the position of one or more stabilizers, the ‘stabilizer’ variable V5 being adapted to assume a first value N1 when at least one stabilizer is in an operating position and adapted to assume a second value N2 when no stabilizer is in the operating position;
a ‘charging’ variable V6 representing the status of a button actuating charging mode, the ‘charging’ variable V6 being adapted to assume a first value N1 when the button actuating charging mode is in the active state and a second value N2 when the button actuating charging mode is in the inactive state.

Nevertheless, in other embodiments this list may comprise more or fewer operating modes depending on the need identified. Likewise other variables could be used to determine the various operating modes. Furthermore, the first value N1 of the variables V1, V2, V4, V5 and V6 can be the same for each of those variables (for example equal to 1 or to ‘Yes’) or different. In the same manner the second value N2 of the variables V1, V2, V4, V5 and V6 can be the same for each of those variables (for example equal to 0 or to ‘No’) or different.

Determination of the various operating modes in the embodiment represented in FIG. 3 will now be described.

Concerning the charging operating mode M1, that mode is determined by means of the ‘driver presence’ variable V2, the ‘control activity’ variable V1 and the ‘charging’ variable V6.

In fact, first of all the control unit 14 receives a value of the ‘control activity’ variable V1, a value of the ‘driver presence’ variable V2 and a value of the ‘charging’ variable V6. The control unit 14 then determines that the operating mode is the charging mode M1 when the ‘driver presence’ variable V2 is equal to the first value N1, the value of the ‘charging’ variable V6 is equal to the first value N1 and the value of the ‘control activity’ variable V1 is equal to the first value N1.

Where the idling operating mode M2 is concerned, that mode is determined in two different ways.

In the first way of determining it this mode M2 is determined by means of the ‘driver presence’ variable V2 and the ‘control activity’ variable V1.

In fact, first of all the control unit 14 receives a value of the ‘control activity’ variable V1 and a value of the ‘driver presence’ variable V2. The control unit 14 then determines that the operating mode is the idling mode M2 when the value of the ‘driver presence’ variable V2 is equal to the second value N2 and the value of the ‘control activity’ variable V1 is equal to the first value N1.

In the second way of determining it this mode M2 is determined by means of the ‘charging’ variable V6 and the ‘control activity’ variable V1.

In fact, first of all the control unit 14 receives a value of the ‘charging’ variable’ V6 and a value of the ‘control activity’ variable V1. The control unit 14 then determines that the operating mode is the idling mode M2 when the value of the ‘charging’ variable V6 is equal to the second value N2 and the value of the ‘control activity’ variable V1 is equal to the first value N1.

Where the road operating mode M6 is concerned, that mode is determined by means of the ‘control activity’ variable V1 and the ‘machine speed’ variable V3.

First of all the control unit 14 receives a value of the ‘control activity’ variable V1 and a value of the ‘machine speed’ variable V3. The control unit 14 compares the value of the ‘machine speed’ variable V3 to the machine speed threshold S2. Finally, the control unit 14 determines that the operating mode is the road mode M6 when the value of the ‘control activity’ variable V1 is equal to the second value N2 and the value of the ‘machine speed’ variable V3 is at or above the machine speed threshold S2.

Where the charging operating mode M5 is concerned, that mode is determined by means of the ‘control activity’ variable V1, the ‘machine speed’ variable V3 and the ‘loading mode active’ variable V4.

The control unit 14 receives a value of the ‘control activity’ variable V1, a value of the ‘machine speed’ variable V3 and a value of the ‘loading mode active’ variable V4. The control unit 14 then compares the value of the ‘machine speed’ variable V3 to the machine speed threshold S2. Finally, the control unit 14 determines that the operating mode is the charging mode M5 when the value of the ‘control activity’ variable V1 is equal to the second value N2, the value of the ‘machine speed’ variable V3 is below the machine speed threshold S2 and the value of the ‘loading mode active’ variable V4 is equal to the first value N1.

Where the handling operating mode M4 is concerned, that mode is determined by means of the ‘control activity’ variable V1, the ‘machine speed’ variable V3, the ‘loading mode active’ variable V4 and the ‘stabilizer’ variable V5.

First of all the control unit 14 receives a value of the ‘control activity’ variable V1, a value of the ‘machine speed’ variable V3, a value of the ‘loading mode active’ variable V4 and a value of the ‘stabilizer’ variable V5. The control unit 14 then compares the value of the ‘machine speed’ variable V3 to the machine speed threshold S2. Finally, the control unit 14 determines that the operating mode is the handling mode M4 when the value of the ‘control activity’ variable V1 is equal to the second value N2, the value of the ‘machine speed’ variable V3 is below the machine speed threshold S2, the value of the ‘loading mode active’ variable V4 is equal to the second value N2 and the value of the ‘stabilizer’ variable V5 is equal to the second value N2.

Where the handling on stabilizers operating mode M5 is concerned, that mode is determined by means of the ‘control activity’ variable V1, the ‘machine speed’ variable V3, the ‘loading mode active’ variable V4 and the ‘stabilizer’ variable V5.

First of all the control unit 14 receives a value of the ‘control activity’ variable V1, a value of the ‘machine speed’ variable V3, a value of the ‘loading mode active’ variable V4 and a value of the ‘stabilizer’ variable V5. The control unit 14 then compares the value of the ‘machine speed’ variable V3 to the machine speed threshold S2. Finally, the control unit 14 determines that the operating mode is the handling mode M4 when the value of the ‘control activity’ variable V1 is equal to the second value N2, the value of the ‘machine speed’ variable V3 is below the machine speed threshold S2, the value of the ‘loading mode active’ variable V4 is equal to the second value N2 and the value of the ‘stabilizer’ variable V5 is equal to the second value N2.

Where the ‘control activity’ variable V1 is concerned, in another embodiment the ‘control activity’ variable V1 can be used in the step of determination of the operating mode in combination with another variable, namely a ‘motor speed’ variable. The ‘motor speed’ variable represents the speed of the electric motor of the driving device 12 that actuates the load-handling device. The ‘motor speed’ variable V1 thus assumes a value that is compared to a motor speed threshold S1. Thus in this other embodiment when the ‘control activity’ variable is equal to the first value N1 and the value of the ‘motor speed’ variable V1 is below the motor speed threshold S1 then the control unit 14 determines either the operating mode M1 or the operating mode M2. Furthermore, when the ‘control activity’ variable is equal to the second value N2 or the value of the ‘motor speed’ variable V1 is greater than or equal to the motor speed threshold S1 then the control unit 14 determines one of the operating modes M3 to M6.

Where the ‘loading mode active’ variable V4 is concerned, in another embodiment the ‘loading mode active’ variable V4 can assume the values N1 and N2 as a function of another parameter. In fact, in this case the ‘loading mode active’ variable V4 represents the identification of the tool 7 and is adapted to assume a first value N1 in response to the detection by a tool of authentication device that the tool 7 is of the bucket type and to assume a second value N2 in response to the detection by a tool authentication device that the tool 7 is of the fork type. The authentication device may be an RFID transmitter-receiver, the tool 7 being equipped with an RFID chip, an optical sensor or any other appropriate type of authentication device.

When the operating mode has been determined the control unit 14 then determines the state of charge of the storage unit 10 and advantageously the phase in which the storage unit 10 is engaged.

To this end the control unit 14 receives the state of charge of the storage unit 10 at a time t and the state of charge at a time t+dt with the aid of the state of charge evaluation device 16, dt being a predetermined time interval. The control unit 14 thus compares the state of charge at time t with the state of charge at time t+dt. The control unit 14 then determines when the state of charge at time t+dt is lower than the state of charge at time t that the storage unit 10 is in the discharging phase SOC−. When the state of charge at time t+dt is greater than the state of charge at time t the control unit 14 determines that the storage unit 10 is in the charging phase SOC+.

When the operating mode, the state of charge at time t and advantageously the phase of the storage unit 10 have been determined the control process advances to the step of controlling the fuel cell 18.

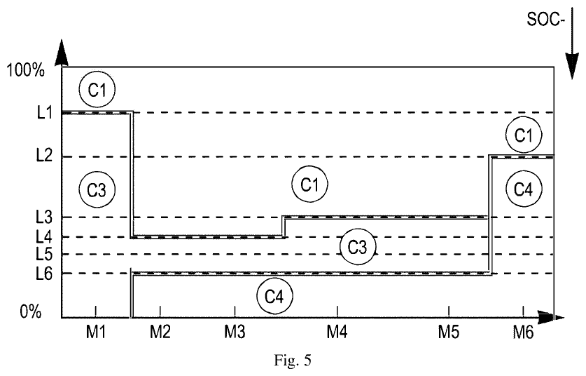

FIGS. 4 and 5 depict for one embodiment diagrams representing the set point value of the fuel cell 18 to be applied to the fuel cell 18 as a function of on the one hand and on the abscissa axis (horizontal axis) the operating mode and on the other hand and on the ordinate axis (vertical axis) the state of charge of the storage unit 10, FIG. 4 concerning the discharging phase and FIG. 5 the charging phase of the storage unit 10.

Thus as soon as the operating mode of the working machine 1 and the mode of the storage unit 10 are known, the control unit 14 compares the state of charge at time t with predetermined state of charge thresholds depending on the operating mode of the working machine 1 and the phase of the storage unit 10.

In the embodiment from FIGS. 4 and 5 six state of charge thresholds L1 to L6 are represented and comprise between 0 and 100% of the maximum state of charge of the storage unit 10 with decreasing values, namely L1>L2>L3>L4>L5>L6.

In these diagrams the solid lines represent changes of set point values when the state of charge exceeds a threshold L1-L6 or the operating mode is modified. The dashed lines depict the value of each threshold for all the operating modes.

As can be seen in these FIGS. 4 and 5 it is advantageous to provide for each operating mode a hysteresis between the charging phase SOC+ and the discharging phase SOC− of the storage unit 10. In fact, the storage unit 10 may go from a charging mode to a discharging mode and vice versa very rapidly as soon as the set point of the fuel cell 18 is modified. Accordingly, passing from a state of charge threshold modifying the set point value could lead to the passage from charging mode to discharging mode and vice versa. This is why, for the same operating mode, the state of charge thresholds modifying the set point value of the fuel cell are different when the storage unit 10 is in the charging phase SOC+ and when the storage unit 10 is in the discharging phase SOC−.

In the embodiment represented the state of charge threshold of a given operating mode to go from a first set point value to a second set point value in the discharging phase of the storage unit 10 is below the state of charge threshold of said operating mode to go from the first set point value to the second set point value in the charging phase of the storage unit 10. In the embodiment represented only the operating mode M1 features no hysteresis. In other words, the state of charge threshold is the same in the charging phase and in the discharging phase.

As represented in FIGS. 4 and 5 the operating mode relies on the use of four different set point values, namely:
a ‘nil’ set point value C1 for which the fuel cell is shut down;
an ‘idling’ set point value C2 corresponding to a power delivered by the fuel cell between 2 and 25% inclusive of a maximum power of the fuel cell;
an ‘average’ set point value C3 corresponding to a power delivered by the fuel cell between 25 and 85% inclusive of the maximum power of the fuel cell;
a ‘maximum’ set point value C4 corresponding to a power delivered by the fuel cell greater than 85% of the maximum power of the fuel cell.

The ‘average’ set point value C3 is advantageously changeable, that is to say modified during the service life of the working machine 1, by a learning method, that is to say as a function of the past use of the working machine 1. In fact, there is provision for initializing the ‘average’ set point value C3 to a predetermined initial set point value that corresponds for example to 50% of the maximum power of the fuel cell 18 and then to calculate an average power delivered during one or more cycles of activity of the working machine 1. The ‘average’ set point value C3 is then modified as a function of the calculated average power. A cycle can be determined for example by identifying starting up and shutting down of the working machine 1.

The embodiment from FIGS. 4 and 5 is more particularly described below.

FIG. 4 more particularly concerns the charging phase SOC+ of the storage unit 10.

In the operating mode M1 there is provision for controlling the fuel cell 18 using:
a ‘nil’ set point value C1 when the state of charge is between L1 and 100% inclusive; and
an ‘average’ set point value C3 when the state of charge is between 0% and L1 inclusive.

In the operating mode M2 there is provision for controlling the fuel cell 18 using:
a ‘nil’ set point value C1 when the state of charge is between L2 and 100% inclusive;
an ‘idling’ set point value C2 when the state of charge is between L3 and L2 inclusive;
an ‘average’ set point value C3 when the state of charge is between L5 and L3 inclusive;
and
a ‘maximum’ set point value C4 when the state of charge is between 0% and L5 inclusive.

In the operating mode M3 there is provision for controlling the fuel cell 18 using:
a ‘nil’ set point value C1 when the state of charge is between L2 and 100% inclusive;
an ‘idling’ set point value C2 when the state of charge is between L3 and L2 inclusive;
an ‘average’ set point value C3 when the state of charge is between L5 and L3 inclusive;
and
a ‘maximum’ set point value C4 when the state of charge is between 0% and L5 inclusive.

In the operating mode M4 there is provision for controlling the fuel cell 18 using:
a ‘nil’ set point value C1 when the state of charge is between L2 and 100% inclusive;
an ‘average’ set point value C3 when the state of charge is between L5 and L2 inclusive;
and
a ‘maximum’ set point value C4 when the state of charge is between 0% and L5 inclusive.

In the operating mode M5 there is provision for controlling the fuel cell 18 using:
a ‘nil’ set point value C1 when the state of charge is between L2 and 100% inclusive;
an ‘average’ set point value C3 when the state of charge is between L4 and L2 inclusive;
and
a ‘maximum’ set point value C4 when the state of charge is between 0% and L4 inclusive.

In the operating mode M6 there is provision for controlling the fuel cell 18 using:
a ‘nil’ set point value C1 when the state of charge is between L1 and 100% inclusive; and
a ‘maximum’ set point value C4 when the state of charge is between 0% and L1 inclusive.

FIG. 5 more particularly concerns the discharging phase SOC− of the storage unit 10.

In the operating mode M1 there is provision for controlling the fuel cell 18 using:
a ‘nil’ set point value C1 when the state of charge is between L1 and 100% inclusive; and
an ‘average’ set point value C3 when the state of charge is between 0% and L1 inclusive.

In the operating mode M2 there is provision for controlling the fuel cell 18 using:
a ‘nil’ set point value C1 when the state of charge is between L4 and 100% inclusive;
an ‘average’ set point value C3 when the state of charge is between L6 and L4 inclusive;
and
a ‘maximum’ set point value C4 when the state of charge is between 0% and L6 inclusive.

In the operating mode M3 there is provision for controlling the fuel cell 18 using:
a ‘nil’ set point value C1 when the state of charge is between L4 and 100% inclusive;
an ‘average’ set point value C3 when the state of charge is between L6 and L4 inclusive;
and
a ‘maximum’ set point value C4 when the state of charge is between 0% and L6 inclusive.

In the operating mode M4 there is provision for controlling the fuel cell 18 using:
a ‘nil’ set point value C1 when the state of charge is between L3 and 100% inclusive;
an ‘average’ set point value C3 when the state of charge is between L6 and L3 inclusive;
and
a ‘maximum’ set point value C4 when the state of charge is between 0% and L6 inclusive.

In the operating mode M5 there is provision for controlling the fuel cell 18 using:
a ‘nil’ set point value C1 when the state of charge is between L3 and 100% inclusive;
an ‘average’ set point value C3 when the state of charge is between L6 and L3 inclusive;
and
a ‘maximum’ set point value C4 when the state of charge is between 0% and L6 inclusive.

In the operating mode M6 there is provision for controlling the fuel cell 18 using:
a ‘nil’ set point value C1 when the state of charge is between L2 and 100% inclusive; and
a ‘maximum’ set point value C4 when the state of charge is between 0% and L2 inclusive.

The embodiment described hereinabove is merely one example of the invention. Other embodiments could be used. Those embodiments could therefore comprise a different number of operating modes, different state of charge thresholds and different numbers thereof, as well as different set points of the fuel cell. In fact, intermediate set points could be introduced between the set points C1-C4, for example, a number of state of charge thresholds less than or greater than 6, etc.

In order to determine if the set point applied to the fuel cell 18 must be modified the steps of the method of controlling the fuel cell 18 are repeated regularly in accordance with a predetermined schedule in order to determine if the operating mode of the working machine 1, the state of charge of the storage unit 10 and/or the phase of the storage unit 10 have been modified.

The functions and steps described hereinabove may be implemented in the form of a computer program or by hardware components (for example programmable gate arrays). In particular, the functions and steps employed by the control unit may be sets of instructions or computer modules implemented in a processor or controller or by dedicated electronic components or FPGA or ASIC type components. It is also possible to combine computer parts and electronic parts.

When it is specified that a control unit is configured to carry out a given operation that means that this element comprises computer instructions and corresponding execution means that enable said operation to be performed and/or that this element comprises corresponding electronic components.

In particular, the steps of the method proposed hereinabove may be implemented in a non-transitory computer program that to this end comprises program code instructions for the execution of the steps of said method. Said program may then be executed by a processor of a working machine as proposed hereinabove.

Any reference throughout the specification to ‘an embodiment’ means that a particular feature, structure or functionality described with reference to one embodiment is included in at least one embodiment of the present invention. Thus the occurrence of the expression ‘in one embodiment’ at various places throughout the specification does not necessarily refer to the same embodiment. Furthermore, the particular features, structures or functionalities may be combined in any appropriate manner in one or more embodiments.

Although the invention has been described with reference to particular embodiments it is obvious that it is in no way limited to them and that it encompasses all technical equivalents and combinations of the means described if they fall within the scope of the invention.

Use of the verb ‘include’ or ‘comprise’ and its conjugate forms does not exclude the presence of elements or steps other than those stated in a claim.

In the claims any reference sign between parentheses should not be interpreted as a limitation of the claim.

1. A method of controlling a fuel cell of a working machine, the working machine including a load-handling device formed of an arm and a tool, at least one electric motor that is configured to move the working machine or to actuate the load-handling device, an energy storage unit configured to supply energy to the at least one electric motor, a fuel cell that is connected to the energy storage unit and configured to charge the energy storage unit, a first control member configured to control the electric motor, and a second control member configured to control the load-handling device, the method including the following steps:
determining an operating mode of the working machine as one of at least two operating modes as a function of at least one of the following variables:
a driver presence variable representing the presence of a person on a driver's seat of the working machine;
a loading mode active variable representing the activity of the load-handling device;
a stabilizer variable representing a position of one or more stabilizers;
a charging variable representing a state of a button actuating charging mode; and
a control activity variable representing the activity of the first control member or of the second control member;
determining a state of charge of the energy storage unit; and
controlling the fuel cell using a predetermined set point as a function of the state of charge of the energy storage unit and the operating mode of the working machine so determined.

2. The method of claim 1, wherein one of the determined operating modes is an idling mode that is determined by means of the driver presence variable and the control activity variable.

3. The method of claim 2, further comprising the following steps:
receiving the driver presence variable and the control activity variable, the driver presence variable being a first presence value when a person is present on a driver's seat of the working machine and a second presence value when nobody is present on the driver's seat, the control activity variable being a first control activity value when the first control member and the second control member have not been activated by a user and a second control activity value when one of the first control member or the second control member has been activated by a user; and
determining that the operating mode is the idling mode when the control activity variable is equal to the first control activity value and the driver presence variable is equal to the second presence value.

4. The method of claim 3, wherein one of the operating modes is a charging mode that is determined by means of the driver presence variable, the control activity variable, and the charging variable.

5. The method of claim 4, further comprising the following steps:
receiving the driver presence variable, the control activity variable, and the charging variable, the driver presence variable being a first value when a person is present on a seat of the machine and a second value when nobody is present on the seat, the charging variable being a first charging value when the button actuating charging mode is in an active state and a second charging value when the button actuating charging mode is in an inactive state, the control activity variable being a first control activity value when the first control member and the second control member are in a neutral position and a second control activity value when the first control member or the second control member is in an active position; and
determining that the operating mode is the charging mode when the control activity variable is equal to the first control activity value, the driver presence variable is equal to the first presence value, and the charging variable is equal to the first charging value.

6. The method of claim 1, wherein one of the operating modes is a charging mode that is determined by means of a machine speed variable representing a speed of movement of the working machine, the control activity variable, and the loading mode active variable.

7. The method of claim 6, further comprising the following steps:
receiving the machine speed variable, the control activity variable, and the loading mode active variable, the loading mode active variable being a first loading value in response to a hydraulic flow rate of a cylinder for tilting the tool being in a predetermined flow rate range for a duration greater than a predetermined duration threshold and to the detection of an angle of the arm in a predetermined angle range and a second loading value in response to the hydraulic flow rate of the cylinder not being in the predetermined flow rate range for a duration greater than the predetermined duration threshold and to the detection of the angle of the arm not being in the predetermined angle range, the control activity variable being a first control activity value when the first control member and the second control member are in a neutral position and a second control activity value when the first control member or the second control member is in an active position;
comparing the machine speed variable to a predetermined machine speed threshold; and
determining that the operating mode is the charging mode when the control activity variable is equal to the second control activity value, the machine speed variable is below the predetermined machine speed threshold, and the loading mode active variable is equal to the first loading value.

8. The method of claim 1, wherein one of the operating modes is a handling mode determined by means of a machine speed variable representing a speed of movement of the working machine, the control activity variable, the loading mode active variable, and the stabilizer variable.

9. The method of claim 8, further comprising the following steps:
receiving the machine speed variable, the control activity variable, the loading mode active variable, and the stabilizer variable, the loading mode active variable being adapted to assume a first loading value in response to a hydraulic flow rate of a cylinder for tilting the tool being in a predetermined flow rate range for a duration greater than a predetermined duration threshold and to the detection of an angle of the arm in a predetermined angle range and a second loading value in response to the hydraulic flow rate of the cylinder not being in the predetermined flow rate range for a duration greater than the predetermined duration threshold and to the detection of the angle of the arm not being in the predetermined angle range, the stabilizer variable being a first stabilizer value when at least one stabilizer is in an operating position and a second stabilizer value when no stabilizer is in the operating position, the control activity variable being a first control activity value when the first control member and the second control member are in a neutral position and a second control activity value when the first control member or the second control member is in an active position;
comparing the machine speed variable to a predetermined machine speed threshold; and
determining that the operating mode is the handling mode when the control activity variable is equal to the second control activity value, the machine speed variable has a speed value below the predetermined machine speed threshold, the loading mode active variable is equal to the first loading value, and the stabilizer variable is equal to the second stabilizer value.

10. The method of claim 1, wherein the step of controlling the fuel cell cell includes the following sub-steps:
comparing the state of charge determined to a state of charge threshold;
when the state of charge is above the state of charge threshold, controlling the fuel cell using a predetermined set point having a first set point value; and
when the state of charge is below the state of charge threshold, controlling the fuel cell using a predetermined set point having a second set point value, the second set point value being higher than the first set point value.

11. The method of claim 1, wherein the step of
determining of the state of charge includes the following sub-steps:
determining the state of charge at a time t;
determining the state of charge at a time t+dt, dt being a predetermined time interval;
comparing the state of charge at time t and the state of charge at time t+dt;
when the state of charge at time t+dt is lower than the state of charge at time t, determining that the energy storage unit is in a discharging phase;
when the state of charge at time t+dt is greater than the state of charge at time t, determining that the energy storage unit is in a charging phase;
wherein the step of controlling the fuel cell includes, in the discharging phase of the energy storage unit, the following sub-steps:
comparing the state of charge determined to a first state of charge threshold;
when the state of charge is above the first state of charge threshold, controlling the fuel cell using a predetermined set point having a first set point value;
when the state of charge is below the first state of charge threshold, controlling the fuel cell using a predetermined set point having a second set point value, the second set point value being higher than the first set point value;
and wherein the step of controlling the fuel cell includes, in the charging phase of the energy storage unit, the following sub-steps:
comparing the state of charge determined to a second state of charge threshold, the first state of charge threshold being different from the second state of charge threshold;
when the state of charge is above the second state of charge threshold, controlling the fuel cell using a predetermined set point having the first set point value; and
when the state of charge is below the second state of charge threshold, controlling the fuel cell using a predetermined set point having the second set point value.

12. The method of claim 10, wherein the first and second set point values correspond to two of the following set point values:
a nil set point value for which the fuel cell is shut down;
an idling set point value corresponding to a power delivered by the fuel cell between 2% and 25%, inclusive, of a maximum power of the fuel cell;
an average set point value corresponding to a power delivered by the fuel cell between 25% and 85%, inclusive, of the maximum power of the fuel cell; and
a maximum set point value corresponding to a power delivered by the fuel cell greater than 85% of the maximum power of the fuel cell.

13. The method of claim 12, wherein the average set point value is adjusted during a service life of the working machine in accordance with the following steps:
initializing the average set point value to a predetermined initial set point value;
calculating an average power delivered during one or more cycles of activity of the working machine; and
modifying the average set point value as a function of the calculated average power.

14. A working machine comprising:
an electric motor configured to operably drive one or more of the working machine and a load-handling device;
an energy storage unit connected to the electric motor;
a fuel cell configured to charge the energy storage unit;
a first control member configured to control the electric motor;
a second control member configured to control the load-handling device; and
a controller configured to:
determine an operating mode from one or more operating modes of the working machine based on one or more of:
a driver presence variable that represents whether a driver is present aboard the working machine,
a loading mode active variable that represents activity of the load-handling device,
a stabilizer variable that represents a position of a stabilizer,
a charging variable that represents a state of a charging mode actuating button, and
a control activity variable that represents activity of the first control member and/or of the second control member;
determine a charge of the energy storage unit, and
control the fuel cell using a predetermined set point based on the charge and the determined operating mode.

15. The working machine of claim 14, wherein one of the operating modes is an idling mode determined based on the driver presence variable and the control activity variable.

16. The working machine of claim 15, wherein the controller is further configured to:
receive the driver presence variable and the control activity variable,
the driver presence variable being a first presence value when a driver is present on a driver's seat of the working machine and a second presence value when the driver's seat is unoccupied,
the control activity variable being a first control value when the first control member and the second control member are inactive and a second control value when one or more of the first control member and the second control member is active, and
determine that the operating mode is the idling mode when the control activity variable is equal to the first control value and the driver presence variable is equal to the second presence value.

17. The working machine of claim 14, wherein one of the operating modes is a charging mode determined based on the driver presence variable, the control activity variable, and the charging variable.

18. The working machine of claim 17, wherein the controller is configured to:
receive the driver presence variable, the control activity variable, and the charging variable,
the driver presence variable being a first presence value when a driver is present in a driver's seat of the working machine and a second presence value when the driver's seat is unoccupied,
the charging variable being a first charging value when the charging mode actuating button is active and a second charging value when the charging mode actuating button is inactive,
the control activity variable being a first control value when the first control member and the second control member are in a neutral position and a second control value when one or more of the first control member and the second control member is active,
determine that the operating mode is the charging mode when the control activity variable is equal to the first control value, the driver presence variable is equal to the first presence value, and the charging variable is equal to the first charging value.

19. The working machine of claim 14, wherein one of the operating modes is a charging mode determined via a machine speed variable based on a movement speed of the working machine, the control activity variable, and the loading mode active variable.

20. The working machine of claim 19, wherein the controller is configured to:
receive the machine speed variable, the control activity variable, and the loading mode active variable,
the loading mode active variable being a first loading value in response to detecting a hydraulic flow rate set point of a cylinder for tilting a tool of the of the load-handling device being in a predetermined flow rate range for longer than a predetermined duration threshold, and to detecting an angle of an arm of the load-handling device in a predetermined angular range,
the loading mode active variable being a second loading value in response to detecting the hydraulic flow rate set point being in the predetermined flow rate range within the predetermined duration threshold, and to detecting the angle outside of the predetermined angular range,
the control activity variable being a first control value when the first control member and the second control member are in a neutral position and a second control value when the first control member or the second control member is in an active position;
compare the machine speed variable to a predetermined machine speed threshold; and
determine that the operating mode is the charging mode when the control activity variable is equal to the second control value, the machine speed variable has a value below the predetermined machine speed threshold, and the loading mode active variable is equal to the first loading value.
